(19) United States
(12) Patent Application Publication
(10) Pub. No.: US 2013/0284980 A1
(43) Pub. Date: Oct. 31, 2013

(54) Catalyst Comprising Active Particles Physically Pinned to the Support

(71) Applicants: Pascal Del-Gallo, Dourdan (FR); Fabrice Rossignol, Verneuil Sur Vienne (FR); Thierry Chartier, Feytiat (FR); Raphael Faure, Villebon-Sur-Yvette (FR); Claire Bonhomme, Panazol (FR); Sébastien Goudalle, Limoges (FR)

(72) Inventors: Pascal Del-Gallo, Dourdan (FR); Fabrice Rossignol, Verneuil Sur Vienne (FR); Thierry Chartier, Feytiat (FR); Raphael Faure, Villebon-Sur-Yvette (FR); Claire Bonhomme, Panazol (FR); Sébastien Goudalle, Limoges (FR)

(73) Assignees: Universite De Limoges, Limoges (FR); L'Air Liquide Societe Anonyme Pour L'Etude Et L'Exploitation Des Procedes Georges Claude, Paris (FR)

(21) Appl. No.: 13/918,291

(22) PCT Filed: Dec. 14, 2011
(86) PCT No.: PCT/FR2011/052974

§ 371 Date: Jun. 14, 2013

(30) Foreign Application Priority Data
Dec. 16, 2010 (FR) 1060630

(51) Int. Cl. B01J 23/78; B01J 23/58

(52) U.S. Cl. CPC B01J 23/78; B01J 23/58
USPC 252/372; 502/300; 502/337; 502/325

(57) ABSTRACT

Catalyst comprising: a) a catalytic ceramic support comprising an arrangement of crystallites of the same size, same isodiametric morphology and same chemical composition or substantially of the same size, same isodiametric morphology and same chemical composition in which each crystallite is in point contact or virtually point contact with crystallites that surround it, and b) at least one active phase comprising metallic particles mechanically anchored into said catalytic support so that the coalescence and the mobility of each particle are limited to a volume corresponding to that of a crystallite of said catalytic ceramic support.

The present invention relates to a catalyst comprising active particles fixed physically on the ceramic catalyst support.

Heterogeneous catalysis is vital to numerous applications in the chemical, food, pharmaceutical, automotive, and petrochemical industries.

A catalyst is a material which converts reactants to product in the course of repeated and uninterrupted cycles of unit phases. The catalyst participates in the conversion, returning to its original state at the end of each cycle throughout its lifetime. A catalyst modifies the reaction kinetics without changing the thermodynamics of the reaction.

In order to maximize the degree of conversion of supported catalysts it is essential to maximize the accessibility of the active particles for the reactants. In order to understand the advantage of a catalyst such as that presently claimed, the principal steps in a heterogeneously catalyzed reaction should first be recalled. A gas composed of molecules A passes through a catalyst bed and reacts at the surface of the catalyst to form a gas of species B.

Collectively, the unit steps are as follows:

a) transport of reactant A (volume diffusion) through a layer of gas to the outer surface of the catalyst
b) diffusion of species A (volume diffusion or molecular (Knudsen) diffusion) through the pore network of the catalyst to the catalytic surface
c) adsorption of species A on the catalytic surface
d) reaction of A to form B at the catalytic sites present on the surface of the catalyst
e) desorption of the product B from the surface
f) diffusion of species B through the pore network
g) transport of the product B (volume diffusion) from the outer surface of the catalyst, through the layer of gas, to the gas stream.

The catalysts used in the process of methane steam reforming are subject to severe operating conditions: a pressure of around 20 bar and a temperature of from 600° C. to 900° C., in an atmosphere containing primarily the gases CH₄, CO, CO₂, H₂, and H₂O.

The principal problem encountered in the use of catalysts for methane reforming is nowadays in relation to the coalescence of the metal particles. This coalescence leads to a drastic reduction in the metal surface area available for the chemical reaction, and this is manifested in reduced catalytic activity.

A problem which arises, consequently, is to provide an improved catalyst capable of stabilizing the nanometric particles of active phases, under conditions similar to those encountered in methane steam reforming, in order to improve the performance levels thereof.

A solution of the invention is a catalyst comprising:
a) a ceramic catalyst support comprising an arrangement of crystallites of the same size, same isodiametric morphology, and same chemical composition or substantially the same size, same isodiametric morphology, and same chemical composition, in which each crystallite is in point or quasi-point contact with its surrounding crystallites, and
b) at least one active phase(s) comprising metal particles anchored mechanically in said ceramic catalyst support such that the coalescence and mobility of each particle are limited to a maximum volume corresponding to that of one crystallite of said ceramic catalyst support.

A crystallite in the context of the present invention is a domain of material having the same structure as a monocrystal.

Where appropriate, the catalyst according to the invention may exhibit one or more of the following features:
Said arrangement of the ceramic catalyst support is in spinel phase; by spinel phase is meant, for example, the MgAl₂O₄ phase. However, the ceramic catalyst support may also be zirconia, zirconia stabilized with yttrium oxide, silicon carbide, silica, alumina, a silicoaluminous compound, lime, magnesia, a CaO—Al₂O₃ compound, etc.

The metal particles are preferably selected from rhodium, platinum, palladium and/or nickel; generally speaking, the metal particles may be one or more transition metals (Fe, Co, Cu, Ni, Ag, Mo, Cr, etc., NiCo, FeNi, FeCr etc.) or one or more transition metal oxides (CuO, ZnO, NiO, CoO, NiMoO, CuO—ZnO, FeCrO, etc.), one or more noble metals (Pt, Pd, Rh, PtRh, PdPt, etc.) or one or more transition metal oxides (Rh₂O₃, PtO, RhPtO, etc.), or mixtures of transition metals and noble metals, or mixtures of noble metal and transition oxides. In certain reactions the active species may be sulfide compounds (NiS, CoMoS, NiMoS, etc.). In the case under consideration of the steam reforming reaction, the active phases in question will be nickel (Ni), rhodium (Rh) or a mixture (Ni+Rh).
The crystallites have an average equivalent diameter of between 5 and 15 nm, preferably between 11 and 14 nm, and the metal particles have an average equivalent diameter of between 2 and 10 nm, preferably less than 5 nm; the equivalent diameter means the greatest length of the crystallite or of the metal particle if said particle is not strictly spherical.
The arrangement of crystallites is a face-centered cubic or close-packed hexagonal stack in which each crystallite is in point or quasi-point contact with not more than 12 other crystallites in a 3-dimensional space, or, expressed alternatively, 6 other crystallites in a planar space.

The catalyst according to the invention may preferably comprise a substrate in various architectures such as cellular structures, barrels, monoliths, honeycomb structures, spheres, multiscale structured reactor-exchangers (μreactors), etc., which are ceramic or metallic or ceramic-coated metallic, and to which said support can be applied (by washcoating).

The first advantage of the proposed solution relates to the ceramic catalyst support of the active phase. The reason is that said support develops a high available specific surface area of greater than or equal to 50 m²/g, owing to its arrangement and the size of its nanometric particles. Furthermore, the support is stable under severe conditions of methane steam reforming; expressed alternatively, the support is stable at temperatures of between 600° C. and 900° C. and at pressures of between 20 and 30 bar in an atmosphere containing primarily the gases CH₄, CO, CO₂, and H₂O.

The particular architecture of the catalyst support directly influences the stability of the metal particles. The arrangement of the crystallites and the porosity allow development of mechanical anchoring of the metal particles on the surface of the support.

FIG. 1 illustrates the mechanical fixing of the metal particles by the ceramic catalyst support. Firstly, it is clearly apparent that the elementary active particles will at most be of the size of a support crystallite. Secondly, their movement under the combined effect of a high temperature and a water vapor-rich atmosphere nevertheless remains limited to the potential wells represented by the space between two crystallites. The arrows show the only possible movement of the metal particles.

Lastly, it is noteworthy that the mechanical fixing produced by the ceramic catalyst support limits the possible coalescence of the active particles.

The present invention also provides a process for preparing a catalyst as claimed in any of claims 1 to 5, comprising the following steps:
a) preparing a ceramic catalyst support comprising an arrangement of crystallites of the same size, same morphology, and same chemical composition or substantially the same size, same morphology, and same chemical composition, in which each crystallite is in point or quasi-point contact with its surrounding crystallites;
b) impregnating the ceramic catalyst support with a precursor solution of the metallic active phase or phases;
c) calcining the impregnated catalyst in air at a temperature of between 450° C. and 1000° C., preferably at a temperature of between 450° C. and 700° C., more preferably still at a temperature of 500° C., to give an oxidized active phase coated on the surface of the ceramic catalyst support; and
d) reducing the oxidized active phase at between 300° C. and 1000° C., preferably at a temperature of between 300° C. and 600° C., more preferably still at a temperature of 300° C.

Where appropriate, the process for preparing the catalyst according to the invention may feature one or more of the characteristics below:
the impregnation step b) is carried out under vacuum for a duration of between 5 and 60 minutes;
in step b), the solution of active phase is a rhodium nitrate (Rh(NO₃)₃.2H₂O) solution or a nickel nitrate (Ni(NO₃)₂.6H₂O) solution;
said process, after step d), includes a step e) of hydrothermal aging of the catalyst.

The ceramic catalyst support described in step a) of the process for preparing the catalyst according to the invention may be prepared by two processes.

A first process will lead to a ceramic catalyst support comprising a substrate and a film on the surface of said substrate, comprising an arrangement of crystallites of the same size, same isodiametric morphology, and same chemical composition or substantially the same size, same isodiametric morphology, and same chemical composition, in which each crystallite is in point or quasi-point contact with its surrounding crystallites.

A second process will lead to a ceramic catalyst support comprising granules, comprising an arrangement of crystallites of the same size, same isodiametric morphology, and same chemical composition or substantially the same size, same isodiametric morphology, and same chemical composition, in which each crystallite is in point or quasi-point contact with its surrounding crystallites.

Note that the granules are substantially spherical.

The first process for preparing the ceramic catalyst support, especially when the ceramic catalyst support is in spinel phase such as MgAl₂O₄, comprises the following steps:

i) preparation of a sol comprising aluminum nitrate and magnesium nitrate salts, a surfactant, and the solvents water-ethanol and aqueous ammonia;
ii) immersion of a substrate in the sol prepared in step i);
iii) drying of the sol-impregnated substrate so as to give a gelled composite material comprising a substrate covered with a gelled film; and
iv) calcining of the gelled composite material of step iii) in air at a temperature greater than 700° C. and less than or equal to 1100° C., preferably greater than or equal to 800° C., more particularly less than or equal to 1000° C., more preferably still at a temperature greater than or equal to 850° C. and less than or equal to 950° C.

The substrate employed in this first process for preparing the ceramic catalyst support is preferably made of dense alumina.

The second process for preparing the ceramic catalyst support, especially when the ceramic catalyst support is in spinel phase such as MgAl₂O₄, comprises the following steps:

v) preparation of a sol comprising aluminum nitrate and magnesium nitrate salts, a surfactant, and the solvents water-ethanol and aqueous ammonia;
vi) atomization of the sol in contact with a stream of hot air, so as to evaporate the solvent and form a micron-scale powder;
vii) calcining of the powder at a temperature greater than 700° C. and less than or equal to 1100° C., preferably greater than or equal to 800° C., more particularly less than or equal to 1000° C., more preferably still at a temperature greater than or equal to 850° C. and less than or equal to 950° C.

The sol prepared in the two processes for preparing the ceramic catalyst support preferably comprises four main constituents:
Inorganic precursors: for reasons of cost limitation, we have chosen to use magnesium nitrate and aluminum nitrate. The stoichiometry of these nitrates can be verified by ICP (Inductively Coupled Plasma) before they are dissolved in osmosed water.
Surfactant, also called surface-active agent. Use may be made of a Pluronic F127 EO-PO-EO triblock copolymer. It possesses two hydrophilic blocks (EO) and a central hydrophobic block (PO).
Solvent (absolute ethanol).
NH₃.H₂O (28% by mass). The surfactant is dissolved in an ammoniacal solution, which produces hydrogen bonds between the hydrophilic blocks and the inorganic species.

The first step is to dissolve the surfactant (0.9 g) in absolute ethanol (23 ml) and in an ammoniacal solution (4.5 ml). The mixture is then heated at reflux for 1 hour. The solution of nitrates prepared beforehand (20 ml) is subsequently added dropwise to the mixture. The whole mixture is heated at reflux for 1 hour and then cooled to the ambient temperature. The sol thus synthesized is aged in a ventilated oven with an ambient temperature (20° C.) which is precisely controlled.

In the case of the first synthesis process, the immersion involves lowering a substrate into the sol and withdrawing it at a constant rate. The substrates used in the context of our study are alumina plaques sintered at 1700° C. for 1 hour 30 minutes in air (relative density of the substrates=97% in relation to the theoretical density).

During the withdrawal of the substrate, the movement of the substrate entrains the liquid, forming a surface layer. This layer divides in two, with the inner part moving with the substrate and the outer part falling back into the vessel. The progressive evaporation of the solvent leads to the formation of a film on the surface of the substrate.

The thickness of the coating obtained can be estimated from the viscosity of the sol and the drawing rate (equation 1):

e∞κv^{2/3}

where κ is a coating constant that is dependent on the viscosity and the density of the sol and on the liquid-vapor surface tension. v is the drawing rate.

Accordingly, the greater the drawing rate, the greater the thickness of the coating.

The immersed substrates are subsequently oven-heated at between 30° C. and 70° C. for a number of hours. A gel is then formed. Calcining of the substrates in air removes the nitrates and also breaks down the surfactant and thus liberates the porosity.

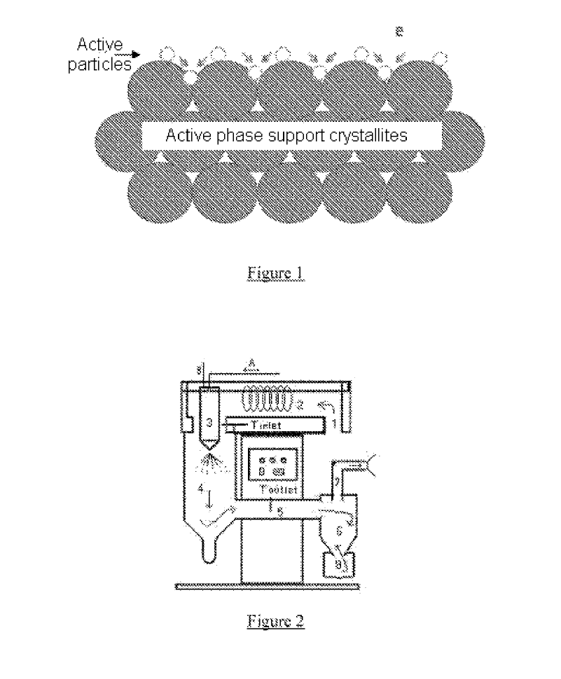

In the case of the second synthesis process, the technique of atomization allows a sol to be converted to a solid, dry form (powder) through the use of a hot intermediate (FIG. 2).

The principle is based on the spraying of the sol 3 into fine droplets in a chamber 4 in contact with a stream of hot air 2 in order to evaporate the solvent.

The powder obtained is carried by the heat flow 5 to a cyclone 6 which will separate the air 7 from the powder 8.

The apparatus which can be used in the context of the present invention is a commercial Büchi 190 Mini Spray Dryer model.

The powder recovered at the end of the atomization is dried in an oven at 70° C. and then calcined.

Calcining at 900° C. destroys the mesostructuring of the coating that was present at 500° C. The crystallization of the spinel phase gives rise to a local disorganization of the porosity. The result, nevertheless, is a ceramic catalyst support according to the invention, in other words an ultrafinely divided and highly porous coating with quasispherical particles in contact with one another (FIG. 3). FIG. 3 corresponds to 3 high-resolution SEM micrographs of the catalyst support with 3 different magnifications.

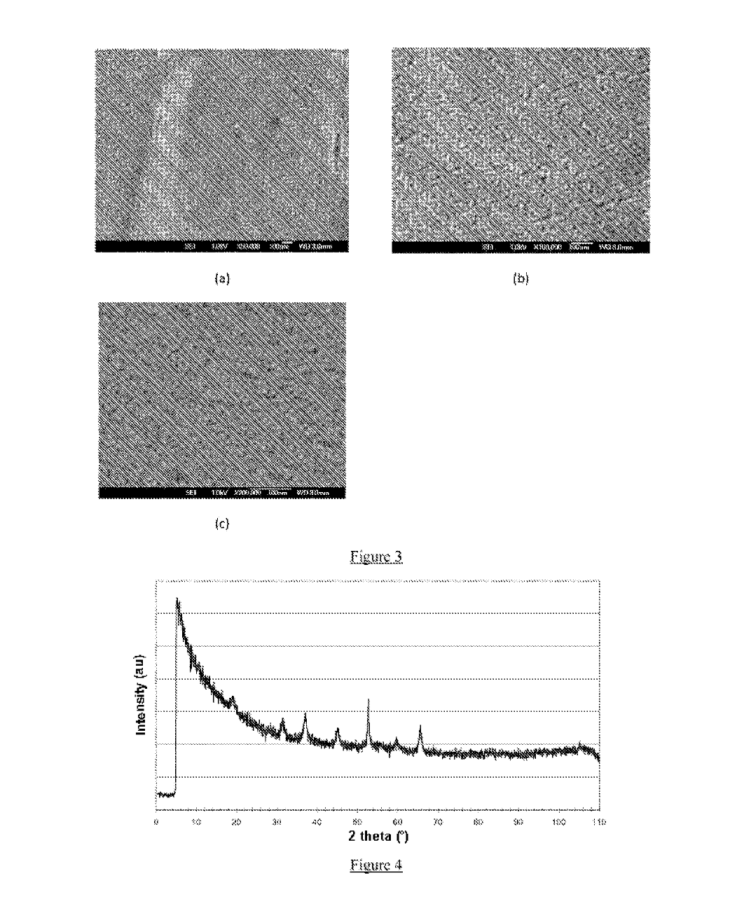

These particles, with a size of the order of ten nanometers, exhibit a very narrow particle-size distribution centered around 12 nm. The average size of the spinel crystallites is 12 nm (measured by small-angle XR diffraction, FIG. 4). This size corresponds to that of the elementary particles observed by scanning electron microscopy, indicating that the elementary particles are monocrystalline.

Small-angle X-ray diffraction (2θ angle values of between 0.5 and 6°): this technique allowed us to determine the size of the crystallites in the catalyst support. The diffractometer used in this study, based on a Debye-Scherrer geometry, is equipped with a curved location detector (Inel CPS 120) in the center of which the sample is positioned. The sample is a monocrystalline sapphire substrate to which the sol has been applied by dip-coating. The Scherrer formula associates the half-height width of the diffraction peaks with the size of the crystallites (equation 2).

$$D = 0.9 \times \frac{λ}{β cos θ} \qquad Equation 2$$

D corresponds to the size of the crystallites (nm)
λ is the wavelength of the Kα ray of Cu (1.5406 Å)
β corresponds to the half-height width of the ray (in rad)
θ corresponds to the diffraction angle.

In the process for preparing the catalyst according to the invention, the ceramic catalyst support is subsequently impregnated with a Ni or Rh precursor solution. The catalyst under study is the catalyst for steam reforming of natural gas.

In the case of an active phase comprising rhodium (catalyst dubbed AlMg+Rh), impregnation is carried out under vacuum for 15 minutes. An Rh nitrate (Rh(NO₃)₃.2H₂O) was employed as inorganic Rh precursor.

The concentration of Rh in the nitrate solution was set at 0.1 g/l. Following impregnation, the catalyst is calcined in air at 500° C. for 4 hours. At this stage, we have a rhodium oxide coated on the surface of the ultrafinely divided support. The active phase is reduced under Ar—H₂ (3% by volume) at 300° C. for 1 hour.

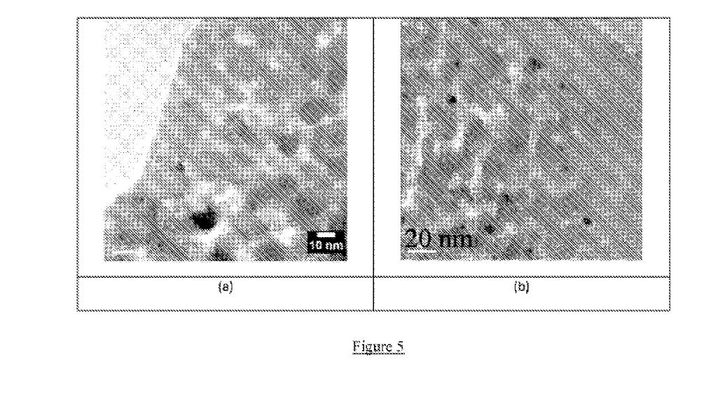

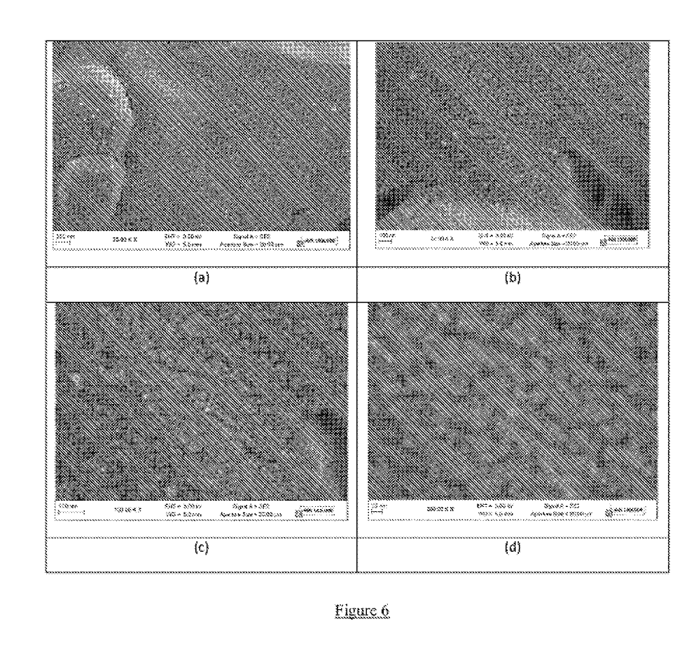

In order to look at the size and the dispersion of metal at the surface of the support, observations were made by transmission electron microscopy (FIG. 5a). These observations show the presence of particles of Rh in the elemental state, with a size of the order of a nanometer. These small particles are concentrated around the spinel particles.

Following hydrothermal aging of this catalyst (900° C., 48 hours, molar water vapor:nitrogen ratio=3:1), the particles of Rh coalesce to a size of 5 nm (FIG. 5b). At this stage, a particle of Rh is stabilized on a particle of spinel support, thereby greatly reducing the possibility of future coalescence of the metal particles during operation of the catalyst.

In the case of an active phase comprising nickel (catalyst dubbed AlMg+Ni), the support is impregnated with a Ni nitrate (Ni(NO₃)₂.6H₂O) solution. The concentration of Ni in this solution can be set at 5 g/l. Following impregnation, the catalyst can be calcined in air at 500° C. for 4 hours and then reduced under Ar—H₂ (3% by volume) at 700° C. for 2 hours.

Results similar to those obtained with the AlMg+Rh catalyst are obtained with the AlMg+Ni catalyst.

We are now going to study the stability over time of a catalyst according to the invention.

The catalyst AlMg+Rh was aged in an SMR reactor (SMR=steam methane reformer) for 20 days. The operating conditions of the reactor are given in table 1.

TABLE 1

| Aging time | Steam/carbon ratio | Pressure |
|---|---|---|
| 20 days | 1.9 molar | 20 bar |

A sample was placed in the top part of the reactor, hence being subject to a temperature of the order of 650° C., and the other sample was placed in the bottom of the reactor, at a temperature of the order of 820° C.

The microstructure of the catalysts emerging from aging was observed by scanning electron microscopy. Since the specimens were similar in the top and bottom of the reactor, we will present the characterizations of the catalysts placed at the bottom of the reactor, at higher temperatures (FIG. 6).

The ultrafinely divided spinel phase support (ceramic catalyst support) is conserved after aging, and the enlargement of the spinel particles is limited.

With regard to the metal particles, the size of the metal particles after aging remains, overall, less than or equal to the size of the elementary crystallites of the spinel support.

The advantage of developing an ultrafinely divided support in order to promote mechanical anchoring of the active phases is largely demonstrated in these micrographs (FIG. 6a). In this figure, indeed, we see that the dispersion of metal is better on the ultrafinely divided coating than on a grain of alumina not covered with a coating, as present on the left in the photograph. At those places where there is no coating, it is impossible to anchor metal particles mechanically, and coalescence is natural.

It will therefore be possible with preference to use the catalyst according to the invention for the steam reforming of methane.

In the context of this study, the reaction relates to the steam reforming of natural gas.

This invention may be extended to diverse applications in heterogeneous catalysis by adapting the active phase or phases to the desired catalytic reaction (automotive pollution abatement, chemical reactions, petrochemical reactions, environmental reactions, etc.) on an ultrafinely divided, spinel-based, ceramic catalyst support.

1-10. (canceled)

11. A catalyst comprising:
a) a ceramic catalyst support comprising an arrangement of crystallites of the same size, same isodiametric morphology, and same chemical composition or substantially the same size, same isodiametric morphology, and same chemical composition, in which each crystallite is in point or quasi-point contact with its surrounding crystallites, and
b) at least one active phase comprising metal particles anchored mechanically in said catalyst support such that the coalescence and mobility of each particle are limited to a maximum volume corresponding to that of one crystallite of said ceramic catalyst support.

12. The catalyst of claim 11, wherein said arrangement is in spinel phase.

13. The catalyst of claim 11, wherein the metal particles are selected from rhodium, platinum, palladium and/or nickel.

14. The catalyst of claim 11, wherein the crystallites have an average equivalent diameter of between 5 and 15 nm, preferably between 11 and 14 nm, and the metal particles have an average equivalent diameter of between 2 and 10 nm, preferably less than 5 nm.

15. The catalyst of claim 11, wherein the arrangement of crystallites is a face-centered cubic or close-packed hexagonal stack in which each crystallite is in point or quasi-point contact with not more than 12 other crystallites in a three-dimensional space.

16. The process for preparing a catalyst of claim 11, comprising the following steps:
a) preparing a ceramic catalyst support comprising an arrangement of crystallites of the same size, same morphology, and same chemical composition or substantially the same size, same morphology, and same chemical composition, in which each crystallite is in point or quasi-point contact with its surrounding crystallites;
b) impregnating the ceramic catalyst support with a precursor solution of the metallic active phase;
c) calcining the impregnated catalyst in air at a temperature of between 450° C. and 1000° C., preferably at a temperature of between 450° C. and 700° C., more preferably still at a temperature of 500° C., to give an oxidized active phase coated on the surface of the catalyst support; and
d) reducing the oxidized active phase at between 300° C. and 1000° C., preferably at a temperature of between 300° C. and 600° C., more preferably still at a temperature of 300° C.

17. The preparation process of claim 16, wherein impregnation step b) is carried out under vacuum for a duration of between 5 and 60 minutes.

18. The process of claim 16, wherein step b) the solution of active phase is a rhodium nitrate (Rh(NO₃)₃.2H₂O) solution or a nickel nitrate (Ni(NO₃)₂.6H₂O) solution.

19. The process of claim 16, wherein said process, after step d), includes a step e) of hydrothermal aging of the catalyst.

20. The use of the catalyst of claim 11 for the steam reforming of methane.
